(19) United States
(12) Patent Application Publication
(10) Pub. No.: US 2025/0183354 A1
(43) Pub. Date: Jun. 5, 2025

(54) POLYANILINE-BASED BATTERY WITH LEAN ELECTROLYTE

(71) Applicant: 2D POLYMER BATTERIES, LLC, Vernon Hills, IL (US)

(72) Inventor: Oleg POSUDIIEVSKYI, Kyiv (UA)

(21) Appl. No.: 18/839,491

(22) PCT Filed: Feb. 19, 2023
(86) PCT No.: PCT/US2023/013401

§ 371 Date: Aug. 19, 2024

Related U.S. Application Data
(60) Provisional application No. 63/312,015, filed on Feb. 20, 2022.

(51) Int. Cl. H01M 10/0525; H01M 4/02; H01M 4/04; H01M 4/1393; H01M 4/1399; H01M 4/36; H01M 4/583; H01M 4/60; H01M 4/62; H01M 10/0562; H01M 10/0565; H01M 10/0569; H01M 10/058

(52) U.S. Cl. CPC H01M 10/0525; H01M 4/0404; H01M 4/0407; H01M 4/1393; H01M 4/1399; H01M 4/364; H01M 4/583; H01M 4/606; H01M 4/622; H01M 10/0562; H01M 10/0565; H01M 10/0569; H01M 10/058; H01M 2004/027; H01M 2004/028; H01M 2300/0068; H01M 2300/0082; H01M 2300/0085; H01M 2300/0091

(57) ABSTRACT

A battery includes a first electrode acting as an anode and a second electrode acting as a cathode, the second electrode including at least one polymer binder, a conductive carbon-based material, and a composite of polyaniline and graphene-based material as an active material. An insulative separator material is disposed between the first and the second electrode that supports transport of lithium ions. The battery further includes an electrolyte composed of at least one aprotic solvent, and at least one lithium salt that is soluble in the at least one aprotic solvent.

### REFERENCE TO RELATED APPLICATIONS

This application claims priority to and the benefit under 35 USC § 119 (e) of U.S. Provisional Patent Application No. 63/312,015 entitled “POLY ANILINE BASED BATTERIES WITH LEAN ELECTROLYTE”, which was filed in the United States Patent and Trademark Office on Feb. 20, 2022, the contents of which are incorporated by reference in their entirety as if fully set forth herein.

### TECHNICAL FIELD

This disclosure relates to rechargeable batteries, in particular, rechargeable batteries utilizing a polyaniline/graphene-based material as a component of the battery cathode.

### BACKGROUND

Rechargeable batteries are a type of secondary battery that can be recharged and used multiple times, making them an environmentally friendly and cost-effective alternative to disposable batteries. They are widely used in portable electronic devices such as smartphones, laptops, and cameras, as well as in larger applications like electric vehicles and energy storage systems. The most common types of rechargeable batteries are nickelcadmium (NiCad), nickel-metal Hydride (NiMH), and Lithium-ion (Li-ion) batteries. Each type of rechargeable battery has its own unique characteristics, including energy density, voltage, and discharge rate, making them well-suited for different applications. Rechargeable batteries must be properly maintained, including being stored correctly, recharged correctly, and being used within the operating temperature range to ensure their performance and longevity. Lightweight rechargeable batteries possessing high charge/discharge energy capacity is a quest of autonomous energetics.

A typical metal-ion battery includes an anode, a cathode, and a liquid electrolyte separating the anode and cathode. The electrolyte is a solution that contains ions, which serve as the charge carriers between the anode and cathode. When the battery is charged, these ions move from the anode to the cathode through the electrolyte, and when the battery is discharged, they move in the opposite direction.

The separator in a liquid electrolyte battery acts as a barrier between the anode and cathode, preventing short-circuits while allowing the ionic flow. The separator is a porous material, usually made of polypropylene, that is soaked in the electrolyte. It allows the flow of ions while retaining the structure of the battery. The separator plays a crucial role in maintaining the stability and safety of the battery, ensuring that the battery operates smoothly and efficiently.

The active material of the anode in a lithium-ion battery is usually based on a graphite substrate which has a theoretical charge capacity of 372 mAh/g. The electrolyte usually consists of a solution of the corresponding metal salt or mixture of salts in an organic solvent, or mixture of organic solvents. Such liquid electrolytes are usually located within the pores of both the anode and cathode with a separator such as polypropylene between them. The quantity and concentration of the liquid electrolyte plays a role in simultaneously providing the lowest battery weight and highest level of ion conductivity.

The cathode active material is usually based on a lithiated transition metal, e.g., nickel-, cobalt-, or manganese, oxides or lithium iron phosphate. Detrimentally, the theoretical charge capacity of such cathode active materials is usually about or below 200 mAh/g. (R. Schmuch et al., “Performance and cost of materials for lithium-based rechargeable automotive batteries”, Nat. Energy. 2018, Vol. 3, P. 267.) Cathode active materials based on transition metal compounds possess other adverse properties that motivate an urgent demand for new cathode active materials, providing significant improvement in battery capacity. (J.-M. Kim et al., “A review on the stability and surface modification of layered transition-metal oxide cathodes”, Materials Today, 2021, Vol. 46, p. 155: G.-L. Xu et al., “Challenges and Strategies to Advance High-Energy Nickel-Rich Layered Lithium Transition Metal Oxide Cathodes for Harsh Operation”, Adv. Func. Mater., 2020, Vol. 30, 2004748: W. Li., “Review—An Unpredictable Hazard in Lithium-ion Batteries from Transition Metal Ions: Dissolution from Cathodes, Deposition on Anodes and Elimination Strategies”, J. Electrochem. Soc., 2020, Vol. 167, 090514.)

Conductive conjugated polymers are a class of polymers that are both electrically conductive and conjugated. Conjugated polymers are materials with a repeating pattern of alternating single and double bonds along the polymer backbone. This alternating arrangement allows for the movement of electrons along the polymer chain, thereby providing electrical conductivity. They are also lightweight and flexible, which makes them ideal for use in wearable devices and flexible electronics. Additionally, they have excellent stability and thermal resistance, making them suitable for use in high-temperature environments.

Conducting conjugated polymers can be an alternative to cathode active materials based on transition metal compounds. For example, polyaniline (PANI) is redox active and is capable of reversible electrochemical transitions at high potentials. These features make PANI a potential candidate for the active component of battery cathodes. (O. A. Kozarenko et al., “Effect of potential range on electrochemical performance of polyaniline as a component of lithium battery electrodes”, Electrochim. Acta, 2015, Vol. 184, p. 111.)

It is known that chemically synthesized PANI doped with HCl is characterized by a specific capacity of about 20 mAh/g in a mixture of ethylene carbonate/dimethyl carbonate/1M LiPF6 electrolyte, which is about 14% of the theoretical capacity of 147 mAh/g utilizing 50% doping of PANI macromolecules. (K. S. Ryu et al., “Comparison of lithium/polyaniline secondary batteries with different dopants of HCl and lithium ionic salts”, J. Power Sources, 2000, Vol. 88, P. 197-201: A. J. Heeger, “Nobel Lecture: Semiconducting and metallic polymers: The fourth generation of polymeric materials”, Rev. Mod. Phys . . . 2001. Vol. 73. P. 681: A. G. MacDiarmid. “Synthetic Metals: A Novel Role for Organic Polymers (Nobel Lecture)”, Angew. Chem. Int. Ed. 2001, 40, 2581: P. Novák et al., “Electrochemically active polymers for rechargeable batteries”, Chem. Rev., 1997, Vol. 97. P. 207.)

It is also known that chemically synthesized PANI doped with lithium salts can exhibit a specific capacity about 100 mAh/g in an analogous electrolyte, representing about 70% of the theoretical capacity. (K. S. Ryu et al., “Polyaniline doped with dimethyl sulfate as a polymer electrode for all solid-state power source system”, Solid State Ionics. 2004, Vol. 175, P. 759.) PANI can also be electrochemically synthesized, purporting a specific capacity of about 100 mAh/g in an organic electrolyte. (H. Daifuku et al., “Electric cells utilizing polyaniline as a positive electrode active material, U.S. Pat. No. 4,717,634 (1988).)

Furthermore yet, PANI doped with lithium salts may be mechanochemically prepared, exhibiting a specific capacity of 146 mAh/g in an organic electrolyte. The resulting capacity is nearly 100% of the theoretical capacity limit utilizing 50% doping of the polymer macromolecules. (O. Posudievsky et al., “Electrochemical performance of mechanochemically prepared polyaniline doped with lithium salt”, Synth. Met., 2012. Vol. 162, p. 2206.)

Recently, it was shown that the doping degree of PANI can exceed 50%. (J. Gaubicher et al., “Lithium-Doped Pernigraniline-Based Materials”, U.S. Pat. No. 10,651,473 (2020).) This was made possible due to exchange of hydrogen atoms connected with nitrogen in the structure of PANI by lithium atoms, although the authors stressed the necessity of anions to support charge/discharge cycling.

A composite of PANI and a graphene-based material (GBM) exhibited considerably greater specific capacity of about 250 mAh/g. The GBM in the PANI/GBM composite is primarily a mixture of multi-, few-, and mono-layered graphene particles. (O. Posudiievskyi, International Patent Application Serial No. PCT/IB2018/055009.) However, it should be noted that no evidence of practical, prolonged charge/discharge cycling of PANI was evidenced. (See, e.g., J. Gaubicher et al., “Lithium-Doped Pernigraniline-Based Materials”, U.S. Pat. No. 10,651,473 (2020): O. Posudiievskyi, ibid.) A consideration and discussion of the electrolyte quantity necessary for practical use of the PANI-based materials in the cathodes of batteries-lithium batteries in particular—was lacking based on the increased PANI doping level.

On the other hand, the practice of doping PANI with anions during redox transitions at high potentials has been reported. (P. Jiménez et al., “Lithium n-Doped Polyaniline as a High-Performance Electroactive Material for Rechargeable Batteries”, Angew. Chem., Int. Ed., 2017, Vol. 56, 1553: M. Charlton et al., “Polyaniline Electrode Activation in Li Cells”, J. Electrochem. Soc., 2020. Vol. 167, 080501.)

The minimal quantity of anions necessary for 50% doping of PANI has been reported to be equal to one anion per two C₆H₄N polymer units: 1 mole of anions per about 182 g of the polymer; or 1 L of a commonly used liquid organic electrolyte with 1M lithium salt concentration per about 182 g of the polymer. (Y. Yamada et al., “Advances and issues in developing salt concentrated battery electrolytes”, Nat. Energy, 2019, Vol. 4, p. 269.)

Accordingly, about 5.5 mL of the electrolyte is required per ˜1 g of the polymer in the cathode mass, or about 5.5 g of the electrolyte per 147 mAh of charge, the theoretical charge storage limit of the polymer. The electrolyte weight to cathode capacity ratio (E/C) in such a system is equal to 37.4 g/(Ah). Such a high E/C value suggests a severe limitation, if not a practical impossibility for PANI-based cathodes in high-performance metal-ion batteries. Indeed, practical lithium-ion batteries exhibit an E/C ratio below 3 g/(Ah). (X. Ren et al., “Enabling High-Voltage Lithium-Metal Batteries under Practical Conditions”, Joule, 2019. Vol. 3, p. 1662: Sh. Chen et al., “Critical Parameters for Evaluating Coin Cells and Pouch Cells of Rechargeable Li-Metal Batteries”, Joule, 2019, Vol. 3, p. 1094; J. Liu et al., “Pathways for practical high-energy long-cycling lithium metal batteries”, Nat. Energy, 2019, Vol. 4, p. 180; H. Li., “Practical Evaluation of Li-Ion Batteries”, Joule, 2019, Vol. 3, p. 911.)

It is theorized that an even higher E/C value (compared with 37.4 g/(Ah) for 50% doped PANI) is possible for charge/discharge cycling of PANI doped with anions, resulting in a higher specific capacity of PANI in a cathode mass of a battery.

### SUMMARY

In general, systems and methods for grounding a new mechanism of PANI charge/discharge processes, free from anion participation, and furthermore based on reversible insertion/extraction of cations is disclosed. The disclosed systems and methods solve the problem of the large quantity of electrolyte previously thought necessary for the functioning of PANI, all the while providing prolonged, reversible charge/discharge cycling of PANI suitable for practical rechargeable batteries.

The disclosed mechanisms suggest the possibility of rocking chair-like functioning of a battery utilizing PANI as the cathode active component. A practical consequence of a constant electrolyte concentration is that the metal-ion conductivity between the electrodes of the batteries is maximized due to the electrode pores being filled, leading to highly efficient metal-ion transport. A minimal quantity of electrolyte sufficient to fill the cathode pores provides an E/C ratio below 3 g/(Ah), as in the best commercial lithium-ion batteries.

In a first general aspect, a battery is disclosed. The battery includes a first electrode acting as an anode and a second electrode acting as a cathode. The second electrode includes at least one polymer binder, a conductive carbon-based material, and an active material. The battery further includes an insulative separator material disposed between the first and second electrode that supports transport of lithium ions, and an electrolyte including at least one aprotic solvent, and at least one lithium salt that is soluble in the at least one aprotic solvent.

In one embodiment, the battery includes a quantity of the electrolyte corresponding to a ratio of the electrolyte weight to the cathode capacity. In a first example, the ratio is less than 10 g/(Ah): in a second example, the ratio is less than 3 g/(Ah).

In one embodiment, the first electrode includes lithium metal, lithium alloy, graphite, a material including graphene, silicon or a material comprised of SiOₓ. In one embodiment, the active material includes a composite of polyaniline and a graphene-based material.

In one embodiment, the electrolyte is a liquid and non-aqueous. In an alternative embodiment, the electrolyte is a solid that includes a lithium ion organic polymer or a lithium ion conducting inorganic compound.

In a second general aspect, a method of fabricating a battery is disclosed. The method includes providing a first electrode acting as an anode and providing a second electrode acting as a cathode, wherein the second electrode includes at least one polymer binder, a conductive carbon-based material and an active material. The method includes disposing an insulative separator material that supports transport of lithium ions between the first and the second electrode. The method further includes providing an electrolyte between the first and second electrode, the electrolyte including at least one aprotic solvent and at least one lithium salt that is soluble in the at least one aprotic solvent.

In one embodiment of the method, the active material includes a composite of polyaniline and a graphene-based material. In a related embodiment, the composite of polyaniline and a graphene-based material is prepared according to a process including milling a mixture of polyaniline in the state of emeraldine base and a graphene-based material according to a relative weight ratio. In one embodiment, the relative weight ratio is between about 75:25 polyaniline to graphene-based material to about 99:1 polyaniline to graphene-based material.

In an embodiment of the method, the milling is performed in a solvent-free environment. In an embodiment of the method, the graphene-based material includes a mixture of multi-, few- and mono-layered graphene particles. The mixture can be prepared by chemical, mechanochemical, electrochemical, sonochemical or thermochemical exfoliation of particles of graphite, graphene oxide, intercalated graphite or expanded graphite.

In one embodiment of the method, the method further includes an optional step of isolating and purifying the polyaniline/graphene-based composite from any other materials present during the milling process.

In one embodiment of the method, the first electrode is formed by a deposition step that includes depositing a cathode mass onto a current collector, wherein the cathode mass includes a binder, a conductive additive, and the active material. In a related embodiment, the binder is water soluble. In a further related embodiment, the binder is polyethylene oxide, styrene-butadiene rubber, alginate, polyacrylic acid, chitosan and water-soluble derivatives thereof, resin, amphiphilic, and gum latexes, polyolefin grafted acrylic acid copolymer, carboxymethylcellulose, β-cyclodextrin, or a combination thereof.

In one embodiment of the method, the deposition step includes preparing a slurry of the cathode mass by mixing the binder, the conductive additive and the active material with water. In a related embodiment, the slurry is free of N-methyl pyrrolidone.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### BRIEF DESCRIPTION OF DRAWINGS

The present embodiments are illustrated by way of the figures of the accompanying drawings, which may not necessarily be to scale, in which like references indicate similar elements, and in which:

FIG. 1 illustrates a cross-section of a rechargeable battery employing a PANI-based cathode according to one embodiment;

FIG. 2 is a chart plotting specific capacity versus cycle number for two different cells, each having different PANI-based cathodes:

FIG. 3 is a chart plotting electric potential versus discharge capacity for cell 1 of the chart of FIG. 2:

FIG. 4 is a chart plotting specific capacity versus cycle number for two different cells, respectively according to one embodiment:

FIG. 5 is a chart plotting specific capacity versus cycle number for a cell according to one embodiment.

### DETAILED DESCRIPTION OF ILLUSTRATIVE EMBODIMENTS

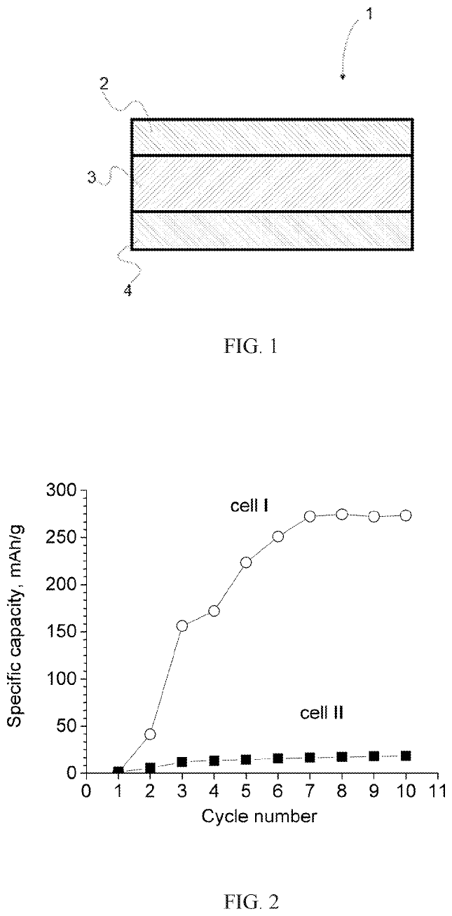

FIG. 1 is an illustrative cross section of a rechargeable battery 1 according to one embodiment. In this embodiment, PANI is utilized as an active component of the cathode. In this embodiment, rechargeable battery 1 includes an anode layer 2, an electrolyte layer 3, and a cathode layer 4. Anode layer 2 can be composed of common anode materials, for example and without limitation, lithium or lithium alloy, or a composite containing lithium. Anode 2 may be composed of non-lithium materials such as, and without limitation, graphite, a graphene-based material, silicon, a SiOₓ-based material or any combination thereof as an active component. It should be understood that lithiated forms of graphite, graphene, silicon or SiOₓ materials should be used if such materials do not contain the necessary amount of lithium metal or lithium ions for optimal battery performance.

In this embodiment, electrolyte layer 3 is a porous polymer membrane. The pores are filled with 1) a liquid electrolyte that is a solution of a lithium salt, or several lithium salts in an organic aprotic solvent or a mixture of different aprotic solvents, and preferably additives serving to improve the electrode-electrolyte interfaces; 2) an organic polymer film having conductivity of lithium ions at optimal concentration of a corresponding lithium salt (e.g., for polyethylene oxide the optimal ratio of oxygen to lithium is about 8:1); 3) a lithiated NAFION or analogous film that possesses intrinsic lithium ion conductivity; 4) a lithium ion conducting, solid inorganic electrolyte; or 5) a combination of any or all of the preceding items 1-5.

In this embodiment, cathode layer 4 contains a PANI and a GBM-based composite as the active component which is disclosed in International Patent Application Serial No. PCT/IB2018/055009, which is incorporated herein by reference in its entirety. In this embodiment, cathode layer 4 is composed of a solvent-free, mechanochemically prepared PANI/GBM composite containing emeraldine base PANI and a mixture of multi-, few-, and mono-layered graphene particles as the GMB. A mechanochemical procedure for preparation of PANI/GBM is analogous in essence to the mechanochemical procedure for preparation of hybrid nanocomposites disclosed in O. Posudievsky et al . . . “Hybrid Two- and Three-Component Host-Guest Nanocomposites and Method for Manufacturing the Same”, U.S. patent application Ser. No. 12/623,000, to GM Global Technology Operations, Inc., which is incorporated herein by reference in its entirety.

Rechargeable battery 1 was shown to exhibit rocking-chair functionality (e.g., cation insertion/extraction induced charge/discharge cycling) utilizing: a lithium metal anode: an electrolyte layer composed of a lithiated NAFION (LIFION) membrane free from any soluble lithium salts such as LiBF4, LiClO4, LiPF6, etc.; and a PANI-based cathode. The rechargeable battery 1 was assembled in a CR 2016 cell in an argon-filled MBRAUN glove box with an oxygen and water content below 0.1 ppm.

In this example, the lithium anode was produced from a Li foil. The LIFION membrane was prepared from a commercial NAFION membrane according to known methods. (J. Gao et al., “Lithiated Nafion as polymer electrolyte for solid-state lithium sulfur batteries using carbon-sulfur composite cathode”, J. Power Sources, 2018, Vol. 382, P. 179.) Before assembling the CR 2016 cell, the LIFION membrane was soaked in anhydrous propylene carbonate.

Investigating the properties of rechargeable battery 1, several cells were fabricated. A first cell, “Cell I”, included a cathode mass formed from mechanochemically prepared PANI and a GBM based composite, with a PANI to GBM weight ratio equal to about 9:1 according to the procedures set forth in International Patent Application Serial No. PCT/IB2018/055009, a polymer binder and a carbon black additive. The weight ratio of the cathode mass components was 85:10:5 (PANI/GBM: polymer binder: carbon black additive). In this example, the polymer binder was a mixture of polyolefin grafted acrylic acid copolymer (3 wt. % aqueous solution) and carboxymethylcellulose (2.5 wt. % aqueous solution) in a 1:3 ratio. In this example, double-distilled water was used to prepare a cathode mass slurry which was deposited on a cathode current collector using a doctor blade. The cathode mass was dried at 60° C. in air and subsequently under vacuum at 80° C. The cathode mass loading was performed so as to ensure a unilateral areal capacity of 3 mAh/cm2.

A second cell, “Cell II” was prepared in an analogous way as Cell I, except that pure emeraldine base PANI was used instead of a composite PANI/GBM.

A third and fourth cell (Cell III and Cell IV, respectively) were assembled to investigate the possibility of achieving the maximum specific capacity of PANI and the prolonged operation of a practical lithium metal battery.

In these examples, Cell III samples were assembled in an analogous procedure as for Cell I samples, except that the electrolyte layer was produced from Celgard 2400 polypropylene membrane (Celgard, LLC, Charlotte, North Carolina, United States) and a 1M solution of LiClO4 in propylene carbonate, as opposed to the LIFION membrane and pure propylene carbonate utilized in Cell I.

Cell IV samples were assembled in an analogous procedure as for Cell III, except that polyvinylidene fluoride (PVDF) binder and N-methyl-2-pyrrolidone (NMP) was used as the solvent during preparation of the slurry for deposition of the PANI/GBM based cathode mass on the cathode current collector.

Referring now to FIG. 2, in this embodiment, the cycling data show increasing electrochemical activity of PANI in Cell I. FIG. 2 illustrates the ability of PANI to sustain charge/discharge cycling in the absence of mobile anions in the electrolyte. Without wishing to be bound by theory, it is postulated that the only anions in the electrolyte are SO³⁻ groups immobilized on the LIFION backbone by covalent bonds. Again, without wishing to be bound by theory, the steady increase of PANI specific capacity is presumed to be due to progressive lithiation of nitrogen atoms within its structure, as doping/de-doping of PANI in the cell during cycling is only able to proceed with participation of lithium cations, because these ions are the only mobile ions contained in the electrolyte.

FIG. 2 also illustrates that PANI within the cathode of Cell I is able to efficiently conduct lithium ions, as without this property PANI could not sustain a progressive increase of its specific capacity during charge-discharge cycling up to nearly 100% doping level.

FIG. 2 furthermore illustrates that efficient functioning of PANI as the active component of the cathode in Cell I is due to the presence and effect of the GBM, because in the absence of GBM particles (and therefore in the absence of interaction between GBM particles and PANI macromolecules) the specific capacity of PANI in Cell II, which does not contain the GBM in the composition of the cathode mass, is lower by nearly a factor of sixteen.

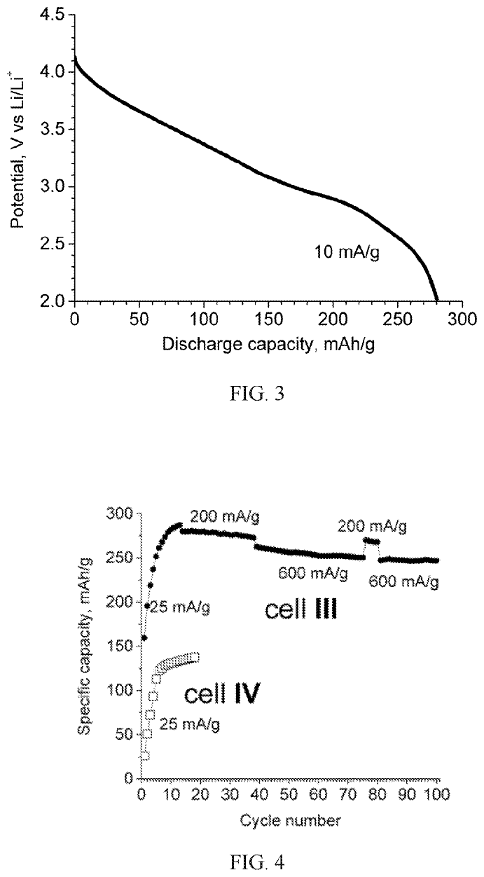

Referring now to FIG. 3, charge-discharge cycle data for Cell I are shown. After a number of charge-discharge cycles, PANI possesses a specific capacity of about 285 mAh/g which corresponds to nearly 100% doping at high potentials. This result is achieved without the use of any lithium salt dissolved in the electrolyte or, for that matter, the battery at all. A conclusion of these data is that a minimum quantity of organic solvent in a high-performance PANI based battery is necessary to fill the pores of anode, cathode, and separator. Optionally, a low quantity of a lithium salt could be dissolved in the organic aprotic solvent as a component of the electrolyte to simultaneously ensure a low battery weight and to provide the necessary level of ion conductivity. These data show that PANI based alkali metal and metal-ion—in particular lithium and lithium-ion-batteries with lean electrolyte and E/C below 3 g/(Ah) can perform as well as, or better than known commercial lithium-ion batteries.

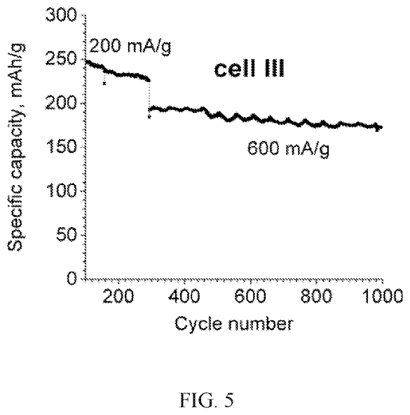

Turning now to FIGS. 4 and 5, it will be realized that PANI in Cell III is characterized by a higher specific capacity of about 285 mAh/g compared with Cell I and Cell IV. In addition, FIG. 4 shows that a common binder (PVDF) together with a common solvent for preparation of the cathode mass slurry (NMP) for cell IV are not applicable in the case of PANI/GBM composite based cathode mass, because NMP partially dissolves PANI. Degradation of PANI can destroy the interaction between PANI and GBM, which in turn can eliminate proceeding of the new doping mechanism of PANI and restricts its specific capacity in Cell IV to the value close to 50% doping. It should be noted that the cathode mass in PCT/IB2018/055009 was produced using poly [(vinylidene fluoride)-co-hexafluoropropylene] as the binder and acetylene as a solvent for preparation of the slurry for deposition of the PANI/GBM composite based cathode mass on the cathode current collector with resulting specific capacity of PANI about 250 mAh/g.

At the same time, solutions of water-soluble binders such as polyacrylic acid and carboxymethylcellulose dissolved in water can be used for preparation of the cathode mass slurry to provide greater specific capacity of PANI, prolonged cycling of lithium metal batteries based thereon, simultaneously ensure lower cost for cathode mass preparation and processing, and reduce usage of organic solvents that pose ecological and environmental hazards associated with battery manufacture.

A number of illustrative embodiments have been described. Nevertheless, it will be understood that various modifications may be made without departing from the spirit and scope of the various embodiments presented herein. Accordingly, other embodiments are within the scope of the following claims.

1. A lithium-ion battery, comprising:
a first electrode comprising a source of lithium ions acting as an anode;
a second electrode acting as a cathode comprising at least one polymer binder, a conductive carbon-based material, and an active material; and
an electrolyte disposed between said first and said second electrodes that supports transport of lithium ions;
wherein said active material comprises a composite comprising polyaniline polymer and a graphene-based material; and
wherein said first electrode, said second electrode, and said electrolyte are operatively assembled to function as a rocking chair-type lithium-ion battery.

2. The battery of claim 1, wherein said battery comprises a quantity of the electrolyte corresponding to a ratio of the electrolyte weight to the cathode capacity.

3. The battery of claim 2, wherein said ratio is less than 3 g/(Ah).

4. The battery of claim 2, wherein said ratio is less than 10 g/(Ah).

5. The battery of claim 1, wherein said first electrode comprises lithium metal, a lithium alloy, lithiated graphite, a lithiated material comprising graphene, lithiated silicon or a lithiated material comprising SiOₓ.

6. (canceled)

7. The battery of claim 1, wherein said electrolyte is:
a non-aqueous liquid electrolyte soaked in an insulative, porous separator; or
a lithium-ion conducting solid.

8. A method of fabricating a battery, comprising:
providing a first electrode acting as an anode;
providing a second electrode acting as a cathode, said second electrode comprising at least one polymer binder, a conductive carbon-based material and an active material;
disposing an electrolyte;
wherein said active material comprises a composite comprising polyaniline and a graphene-based material.

9. (canceled)

10. The method of claim 8, wherein said composite of polyaniline and a graphene-based material is prepared according to a process comprising milling a mixture of polyaniline in the state of emeraldine base and a graphene-based material according to a relative weight ratio.

11. The method of claim 10, wherein said milling is performed in a solvent-free environment.

12. The method of claim 10, wherein said graphene-based material comprises a mixture of multi-, few- and mono-layered graphene particles.

13. The method of claim 12, wherein said mixture is prepared by chemical, mechanochemical, electrochemical, sonochemical or thermochemical exfoliation of particles of graphite, graphene oxide, intercalated graphite or expanded graphite.

14. The method of claim 10, wherein said relative weight ratio is between 50:50 polyaniline to graphene-based material and 99:1 polyaniline to graphene-based material.

15. The method of claim 10, further comprising an optional step of isolating and purifying said polyaniline/graphene-based composite from any other materials present during said milling process.

16. The method of claim 8, wherein said second electrode is formed by a deposition step comprising depositing a cathode mass onto a current collector, said cathode mass comprising a binder, a conductive additive, and said active material.

17. The method of claim 16, wherein said binder is water soluble.

18. The method of claim 17, wherein said binder is polyethylene oxide, styrene-butadiene rubber, alginate, polyacrylic acid, chitosan and water-soluble derivatives thereof, resin, amphiphilic, and gum latexes, polyolefin grafted acrylic acid copolymer, carboxymethylcellulose, β-cyclodextrin, or a combination thereof.

19. The method of claim 16, wherein said deposition step comprises preparing a slurry of said cathode mass by mixing said binder, said conductive additive and said active material with water.

20. (canceled)

21. The lithium-ion battery of claim 1, wherein said active material possesses the reversible capacity to store a charge equal to the charge of one electron per each nitrogen atom of said polyaniline polymer.

22. The lithium-ion battery of claim 7, wherein said non-aqueous liquid electrolyte comprises at least one aprotic solvent, and at least one lithium salt that is soluble in said at least one aprotic solvent.

23. The lithium-ion battery of claim 7, wherein said solid electrolyte comprises a lithium ion conducting organic polymer or a lithium ion conducting inorganic compound.

24. The lithium-ion battery of claim 7, wherein said solid electrolyte is a composite of a lithium ion conducting organic polymer and a lithium ion conducting inorganic material.

25. The lithium-ion battery of claim 7, wherein said solid electrolyte is a lithium ion conducting ionogel.

26. The method of claim 16, wherein said binder is soluble in a polar organic solvent.

27. The method of claim 16, wherein said deposition step comprises preparing a slurry of said cathode mass by mixing said binder, said conductive additive and said active material with a polar organic solvent.

28. The method of claim 27, wherein said slurry is free of N-methyl pyrrolidone.

29. The method of claim 10, wherein said relative weight ratio is between 90:10 polyaniline to graphene-based material and 97:3 polyaniline to graphene-based material.
